(19) United States
(12) Patent Application Publication
(10) Pub. No.: US 2016/0249129 A1
(43) Pub. Date: Aug. 25, 2016

(54) Headphone Earphone Hybrid

(71) Applicant: Caroline Patricia Smith, Alicante (ES)

(72) Inventor: Caroline Patricia Smith, Alicante (ES)

(21) Appl. No.: 14/628,255

(22) Filed: Feb. 22, 2015

(51) Int. Cl. H04R 1/10

(52) U.S. Cl. CPC H04R 1/1091; H04R 1/1008; H04R 1/1016

(57) ABSTRACT

Headphone-earphone hybrid, where the headphones are combined with ‘in-ear’ phones. The outer headphones covering the ear will also have inner earphones which cover or are inserted into the user's ear canal. Both the outer headphone and the inner earphone will emit the same sound simultaneously.

### BACKGROUND INFORMATION

The idea for this invention came about as a result of consideration given to ways to listen to music without interruption from outside noise. There are three main ways of listening to music, one is through speakers in which case anyone within earshot hears the music. Another is through conventional headphones, as in the type which have two cases on a headband, the cases cover all or mostly all of the ear and the third is through in-ear phones, which are small ‘buds’ which are inserted into the ear covering the ear canal or being inserted directly into the ear canal.

The problem with headphones as defined above, for the average user, (not a professional involved in the production of music and sound,) conventional headphones do not adequately block out noise from the listener's surroundings. For example an average person say for example on a train with standard headphones, unless the headphone volume is turned up extremely high, will hear noise from surroundings.

The same problem occurs with an in-ear earphone, the outer part of the ear which captures sound is exposed and unless the volume is turned up extremely high, the listener will still hear outside noise.

### BRIEF SUMMARY

The invention is a combination of the two conventional ways of listening to music discussed Above. The invention is a hybrid of headphone and earphone. The headphone will have an inner earphone combining both methods to eliminate interference from outside sounds and reduce the need for high volume to achieve the drowning out of outside sounds.

The headphone and earphone will be used simultaneously, the earphone is inserted into the ear and the headphone case covers the ear. Sound is emitted from both devices in parallel.

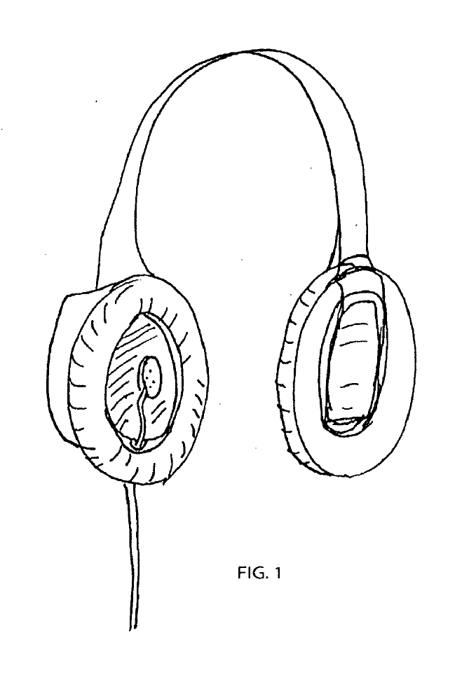

FIG. 1 is a perspective view of the headphone earphone hybrid, showing the earphone inside the headphone (the side with the sound cable)

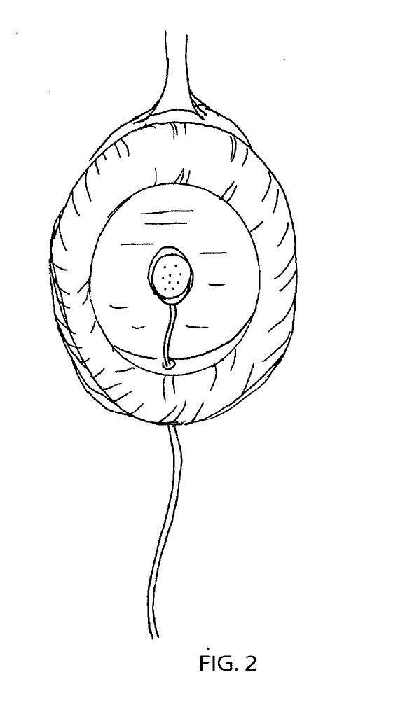

FIG. 2 is a front view of the headphone earphone hybrid showing the earphone inside the headphone. (the side with the sound cable)

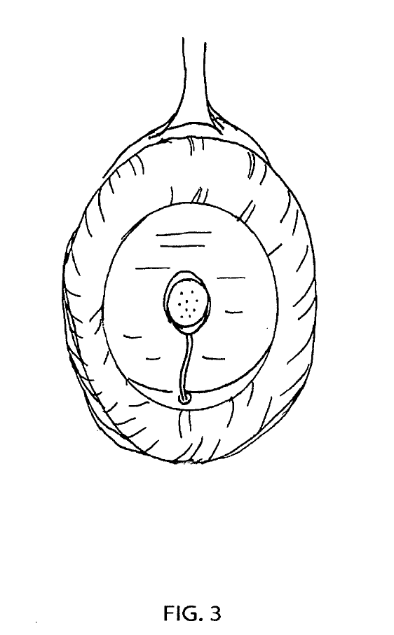

FIG. 3 is a front view of the headphone earphone hybrid showing the earphone inside the headphone (the side without sound cable)

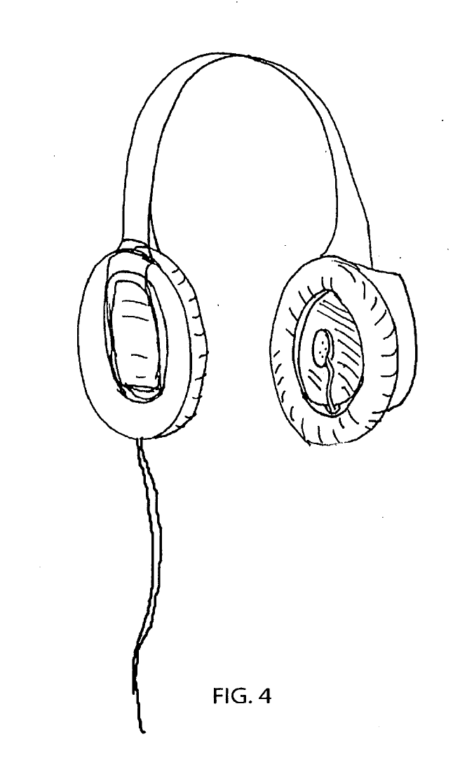

FIG. 4 is a perspective view of the headphone earphone hybrid showing the earphone inside the headphone (the side without sound cable)

### DETAILED DESCRIPTION

A headphone earphone hybrid, where a pair of headphones also contains within the casing covering the ear, an in-ear earphone. With the in-ear earphone inserted into the ear and the outer headphone encasing the ear, sound is delivered though both sources at the same time.

1. The invention is a headphone earphone hybrid by which a set of headphones is combined with inner earphones both devices emitting the same sound simultaneously.
